(19) United States
(12) Patent Application Publication
(10) Pub. No.: US 2010/0031244 A1
(43) Pub. Date: Feb. 4, 2010

(54) Software updating device and computer-readable storage medium storing software updating program

(75) Inventor: Takahiro Koba, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/457,111

(22) Filed: Jun. 1, 2009

(30) Foreign Application Priority Data
Jul. 31, 2008 (JP) 2008-198101

(51) Int. Cl. G06F 9/44

(52) U.S. Cl. 717/168; 707/201; 707/202; 707/E17.01

(57) ABSTRACT

A software updating device includes: a software updating section that obtains through communication an update file for a software installed in an information processing device, and that updates the software using the update file; an update file selecting section that selects the update file for a piece of software set in advance, the update file being used in update of the piece of software by the updating section, and that saves the selected update file in a predetermined storing place; and a backup updating section that updates a backup file of the software stored in a predetermined backup place, by using the update file stored in the storing place.

### CROSS-REFERENCE TO RELATED APPLICATION(S)

This application is based upon and claims the benefit of priority of the prior Japanese Laid-open Patent No. 2008-198101, filed on Jul. 31, 2008, the entire contents of which are incorporated herein by reference.

### FIELD

The embodiments discussed herein are related to a software updating device for updating a software installed in an information processing device, and a computer-readable storage medium storing software updating program.

### BACKGROUND

The information processing device represented by personal computer and the like is installed with OS, driver, and software such as application, and the information processing device performs various functions by executing such software on the information processing device. Such software is often updated for defect repair and the like after being installed in the information processing device.

In updating for defect repair and the like, the software manufacturing company and the like often distributes a updated version updated therefore, a updated version for modifying the already installed software to a structure same as the updated version software, and the like as an update file for free, and the user of the information processing device and the software can acquire the update file to use to update the software.

In order to appropriately update the software, an update program of automatically acquiring the update file from the Internet and updating the software is conventionally known, where the information processing device installed with such update program operates as a updating device.

In addition to such update, the user of the information processing device often acquires a new software and installs the same in the information processing device to cause the information processing device to perform a new function, and often changes the setting of the already installed software to the setting complying with the needs unique to the user.

The status of the software in the information processing device thus changes with elapse of time.

The change in status of the software in the information processing device is not only status change desirable to the user, and may be status change not desirable to the user such as infection to virus software, destroying of software by bug etc., and the like. A technique of saving the backup of the software at the time point the status is normal to prepare for such undesirable status change, and reproducing the normal status using such backup when an undesirable status change (abnormality) occurs is being widely used. A devisal for reducing the capacity of the backup data is disclosed in Japanese Laid-Open Patent Publication No. 2001-297021.

### SUMMARY

However, it is often difficult to determine whether the status of the software is normal or abnormal at a certain time point, and normally, reproduction sometimes needs to be carried out from the state well before the current status. If the software that is the cause of abnormality cannot be specified, a recovery process of returning the information processing device to a purchased state in which only the basic software such as OS is installed is sometimes desirable.

If such recovery or reproduction going back to the past is performed, the update of OS performed from the reproduced past time point to the present and the like all return to the past, and thus the update needs to be again performed after the reproduction, which is cumbersome.

In view of such situation, the disclosure of the present invention aims to provide a software updating device that contributes to simplification of procedures of recovery and the like, and a computer-readable storage medium storing a software updating program.

According to a basic aspect of software updating device includes:

a software updating section that obtains through communication an update file for a software installed in an information processing device, and that updates the software using the update file;

an update file selecting section that selects the update file for a piece of software set in advance, the update file being used in update of the piece of software by the updating section, and that saves the selected update file in a predetermined storing place; and

a backup updating section that updates a backup file of the software stored in a predetermined backup place, by using the update file stored in the storing place.

According to a basic aspect of a computer-readable storage medium storing a software update program which is installed in an information processing device to cause the information processing device to update a software installed in the information processing device; the software update program causing the information processing device to operate as:

a software updating section that obtains through communication an update file for a software installed in an information processing device, and that updates the software using the update file;

an update file selecting section that selects the update file for a piece of software set in advance, the update file being used in update of the piece of software by the updating section, and that saves the selected update file in a predetermined storing place; and

a backup updating section that updates a backup file of the software stored in a predetermined backup place, by using the update file stored in the storing place.

According to such basic mode, a software to be reproduced in time of recovery such as OS and driver is set in advance in the update file selecting section, so that the backup is also updated the software set is updated. Thus, if the status of the software is “reproduced” using such backup, the status in which the update up to the current time point on the OS and the like is completed but extra software is not installed is “reproduced”, and thus procedures of recovery and the like are simplified.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a specific embodiment of a software updating device;

FIG. 2 is a hardware block diagram of the personal computer illustrated in FIG. 1;

FIG. 3 is a view illustrating a configuration of a recovery program;

FIG. 4 is a function block diagram illustrating the function built on the personal computer by the recovery program;

FIG. 5 is a view illustrating several recovery image files saved in the D drive in an at-a-glance chart form;

FIG. 6 is a flowchart illustrating the updating function of the software by the recovery device;

FIG. 7 is a view illustrating a saved update module in the at-a-glance chart form;

FIG. 8 is a view illustrating details of steps S106 and S107 of FIG. 6;

FIG. 9 is a view illustrating a confirmation screen for confirming the update to the user;

FIG. 10 is a view illustrating an image selection screen;

FIG. 11 is a view illustrating a module selection screen;

FIG. 12 is a view illustrating details of steps S110, S111 of FIG. 6;

FIG. 13 is a view illustrating details of step S112 of FIG. 6; and

FIG. 14 is a view illustrating one example of a updated result of the recovery image file.

### DESCRIPTION OF EMBODIMENTS

Specific embodiments of the software updating device and the software updating program storage medium, whose basic modes are described above, will be described below with reference to the drawings.

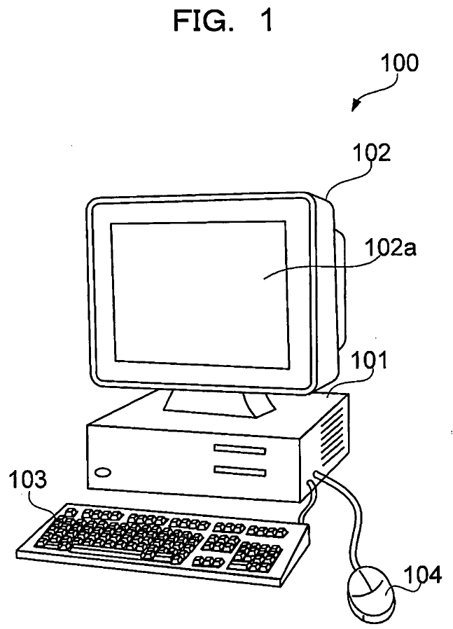

FIG. 1 is a view illustrating a specific embodiment of the software updating device.

In the present embodiment, when a recovery program corresponding to the specific embodiment of the software updating program is installed and executed in a personal computer 100 illustrated in FIG. 1, the personal computer 10 operates as the specific embodiment of the software updating device.

The personal computer 100 includes a main unit 101 including a CPU, a RAM, a hard disc and the like; a display 102 for performing a screen display on a display screen 102a according to an instruction from the main unit 101; a keyboard 103 for inputting an instruction of a user and character information to the computer; and a mouse 104 for specifying an arbitrary position on the display screen 102a to input an instruction corresponding to the position.

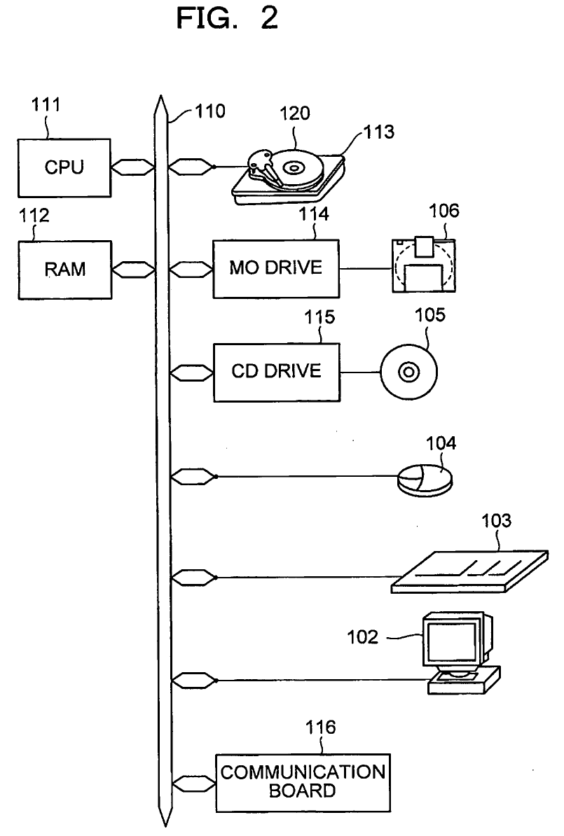

The main unit 101 incorporates a CD drive that is to be loaded in a freely retrievable manner with a CD medium such as CD-ROM 105 (not illustrated in FIG. 1, see FIG. 2) and CD-R, and that reproduces information stored in the loaded CD medium. The main unit 101 also incorporates an MO drive that is to be loaded in a freely retrievable manner with an magneto-optical disc (MO) 106 (not illustrated in FIG. 1, see FIG. 2), and that records and reproduces information to/from the loaded MO 106.

FIG. 2 is a hardware construction view of the personal computer illustrated in FIG. 1.

The hardware construction view illustrates a CPU (Central Processing Unit) 111, a RAM 112, a HDD (hard disc drive) 113, an MO drive 114, a CD drive 115, and a communication board 116, which are mutually connected through a bus 110.

The HDD 113 incorporates a hard disc 120, which is one type of recording medium, and performs records and generates information on the hard disc 120.

The communication board 116 is connected to a connection line such as LAN (Local Area Network) and the like. The personal computer 100 illustrated in FIG. 1 can transmit and receive data to/from another computer through a communication network connected by way of the communication board 116.

FIG. 2 illustrates the mouse 104, the keyboard 103, the CRT display 102, and a printer 200 connected to the bus 110 by way of multiple I/O interfaces (not illustrated).

Here, the CD-ROM 105 stores the recovery program corresponding to one specific embodiment for the basic mode of the software updating program. The CD-ROM 105 is loaded in the main unit 101, and the recovery program stored in the CD-ROM 105 is read by the CD drive 115 and installed in the hard disc 120 via the bus 110.

When the recovery program installed in the hard disc 120 is activated, the recovery program in the hard disc 120 is loaded to the RAM 112, and executed by the CPU 111. Thus, when the recovery program is activated and executed in such manner, the personal computer 100 operates as one specific embodiment of the software updating device. That is, in the example described herein, the personal computer 100 and one embodiment of the software updating program are combined to form one embodiment of the software updating device.

The CD-ROM 105 is illustrated as the storage medium for storing the recovery program, but the storage medium for storing the software updating program of the present disclosure is not limited to a CD-ROM, and may be other storage media such as optical disc, MO, flexible disc, and magnetic tape. The software updating program of the present disclosure may be provided to the computer system directly through the communication network without via the storage medium.

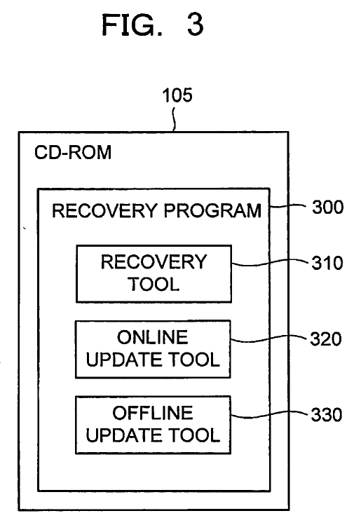

FIG. 3 is a view illustrating a structure of the recovery program.

The recovery program 300 is stored in the CD-ROM 105. The recovery program 300 includes a recovery tool 310, an online update tool 320, and an offline update tool 330. Details will be hereinafter described, but the outline of each tool will be described below.

The recovery tool 310 is a tool for recovering an internal state of the computer, and creates a recovery image and to reproduces the internal state using the recovery image.

The online update tool 320 is a tool for updating the software in the computer online, and acquires the update module from the Internet and updates the software.

The offline update tool 330 is a tool for updating the recovery image used in the recovery using the update module.

Each function built in the personal computer by installing and executing the recovery program 300 in the personal computer 100 illustrated in FIG. 1 will be described.

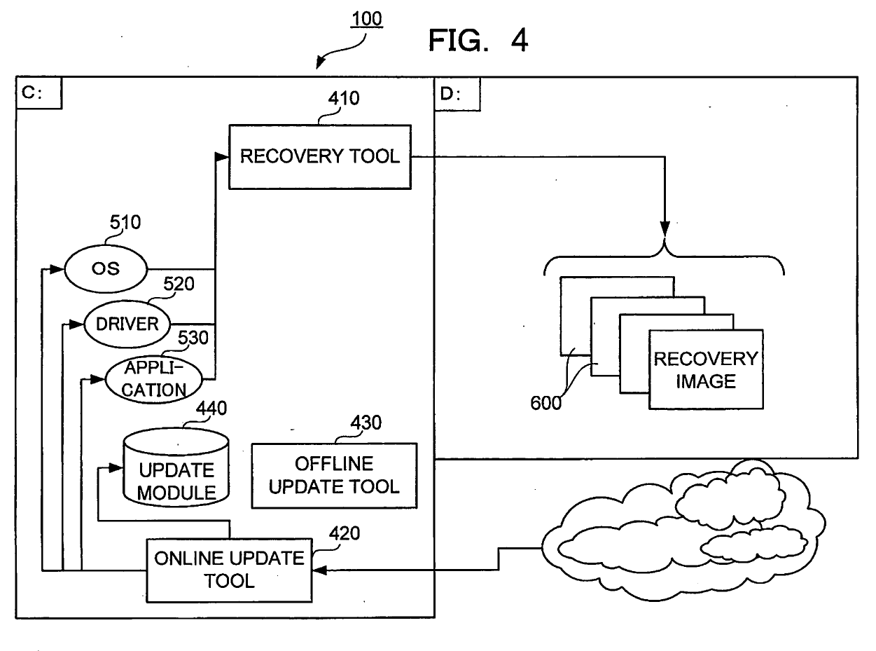

FIG. 4 is a function block diagram illustrating the function built in the personal computer by the recovery program.

The personal computer 100 is prepared with a C drive used as a system folder and a D drive used as a file folder, where when the recovery program 300 illustrated in FIG. 3 is installed in the personal computer 100, a recovery tool 410, an offline update tool 420, and an offline update tool 430 are built on the C drive. The personal computer 100 built with such recovery tool 410, the online update tool 420, and the offline update tool 430 operates as a recovery device of a specific embodiment of the software updating device, the basic modes of which have been previously described.

The recovery tool 410, the online update tool 420, and the offline update tool 430 correspond to the recovery tool 310, the online update tool 320, and the offline update tool 330 constructing the recovery program 300 illustrated in FIG. 3 respectively, but differs in that the elements illustrated in FIG. 3 are constructed only by the application program, whereas the elements illustrated in FIG. 4 are built by combining the application program and the hardware (in particular, CPU etc.) of the personal computer 100. However, in FIG. 4 and each figure described below, the aspect serving as the hardware of each element is omitted, and only the function of each element is abstractly illustrated in blocks.

The C drive of the personal computer 100 is used as the system folder as described above and is installed with an OS 510 and a driver 520. The C drive is installed with an application 530 for causing the personal computer 100 to operate as a desired device (e.g., word processor), including the recovery tool 410 and the like. In FIG. 4, only one driver 520 and one application 530 are illustrated to avoid complication, but such driver 520 and application 530 are generally installed in multiple types. The OS 510 and most drivers 520 are installed in the personal computer 100 from when the user purchased, and some drivers 520 and most applications 530 are added, as appropriate, after the user purchases the personal computer 100.

The outline of the functions of the recovery tool 410, the online update tool 420, and the offline update tool 430 will be described, and thereafter, the details on the function of the recovery device constructed by such tools will be described.

The recovery tool 410 is a tool for providing not only recovery to a complete initial state but also recovery to a state of the personal computer 100 at the desired time point for the user of the personal computer 100. The user instructs the recovery tool 410 to create a recovery image through a predetermined operation when the personal computer 100 is in a state to be reproduced by the subsequent recovery, and the recovery tool 410 creates one recovery image file 600 corresponding to the backup of the entire C drive in response to such instruction. More specifically, all of the OS S510, the driver 520, and the application 530 installed in the C drive at the time point of receiving the instruction are collected and compressed to one file to suppress the capacity of the backup. The user can cause the recovery tool 410 to create multiple recovery image files 600 corresponding to each time point by performing the operation at each of multiple time points when reproduction is desired. The recovery tool 410 saves the multiple recovery image files 600 in the D drive.

Such recovery file image 600 corresponds to one example of a backup file in the basic mode of the software updating device and the software updating program, and the D drive corresponds to one example of the backup place.

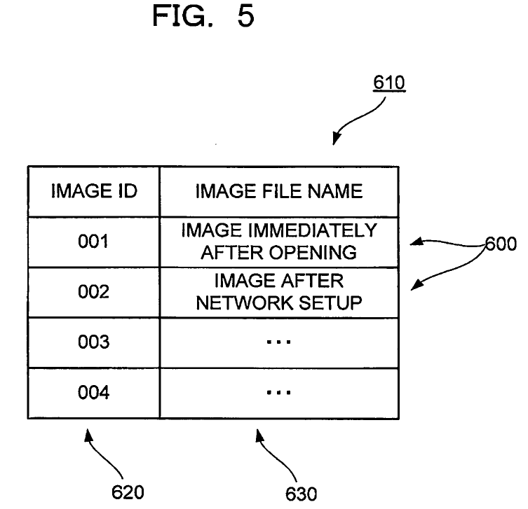

FIG. 5 is a view illustrating the several recovery image files saved in the D drive in the form of a tabulated list.

In the tabulated list 610 illustrated in FIG. 5, four recovery image files 600 are illustrated by way of example, where each recovery image file 600 is provided with an image ID 620 for the recovery device to distinguish the recovery image files 600 from each other, and an image file name 630 for the user to check the content of each recovery image file 600. The technique itself of creating the recovery image file 600 and performing the recovery using such recovery image file 600 are known techniques, and thus further detailed description on the techniques of recovery will be omitted.

As described above, the time point when the recovery image file 600 is created is an arbitrary time point according to the operation of the user, but the recovery image file 600 is desirably created when the personal computer is in the initial state to a certain extent in view of the original role of the recovery. In the example illustrated in FIG. 5, as indicated by the image file name 630, one recovery image file 600 is created immediately after (time point of first start-up) the personal computer is purchased and opened, and thereafter, one recovery image file 600 is created at the time point the network setup is completed. As the recovery image files 600 are created at such time points, the personal computer can be returned by the recovery image file 600 when the personal computer is desired to be returned to a “clean” state at the subsequent time point. The description will be continued returning to FIG. 4.

The online update tool 420 is a tool for accessing the Internet 700, acquiring the update module for updating the OS 510, the driver 520, and the application 530, and updating the OS 510, the driver 520, and the application 530 with the update module. The update module may be a updated version of the OS 510, the driver 520, and the application 530, but may be a program for partially correcting the OS 510, the driver 520, and the application 530 to substantially obtain the updated version. The technique itself of acquiring the update module from the Internet 700 and the like, and updating the OS and the like is also known as a program attached to the OS, and thus further detailed description thereof will be omitted.

The online update module 430 is a tool for updating the recovery image 600 using the update module acquired by the online update tool 420.

The details of the updating function of the software by the recovery device will be described below with reference to the flowchart and the like.

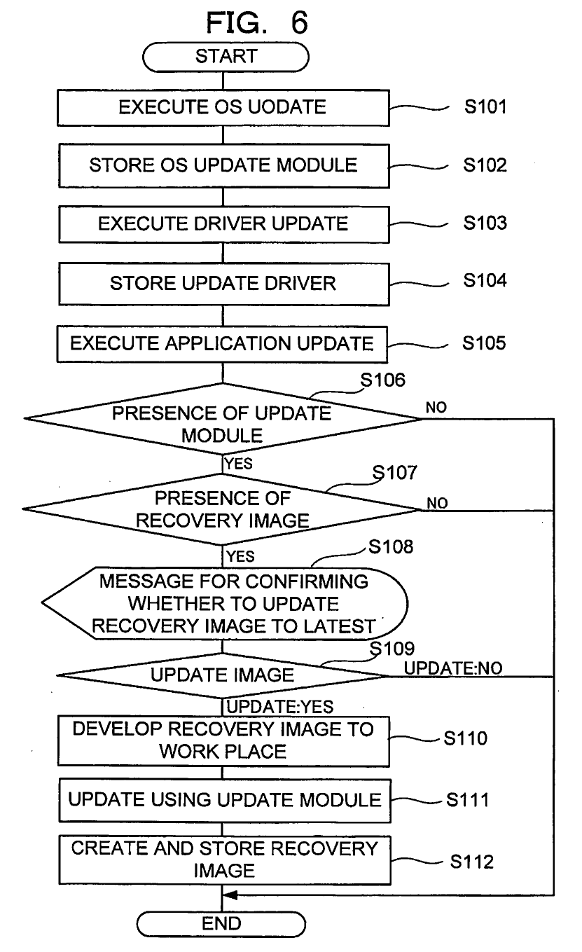

FIG. 6 is a flowchart illustrating the updating function of the software by the recovery device.

The recovery device executes update of the OS according to the setting of the user such as a predetermined time of the day or start-up of the personal computer (step S101). More specifically, as illustrated in FIG. 4, the online update tool 420 accesses the Internet 700 and acquires the update module of the OS 510 from the Internet site provided by the manufacturer of the OS 510. The update module is then executed to update the OS 510.

The recovery device that has executed the update of the OS then saves the update module used for such update (step S102). More specifically, the online update tool 420 saves the update module in a saved file 440 in the C drive. The saved file 440 is a file hidden so that the user cannot access.

The recovery device then executes update on the driver similarly to the OS (step S103), and saves the update module (normally, a updated version of the driver) used in the update of the driver in the save file 440 illustrated in FIG. 4 (step S104).

The recovery device then executes the update on the application (step S105).

The online update tool 420 illustrated in FIG. 4 executes update for all of the OS 510, the driver 520, and the application 530 installed in the personal computer 100. The online update tool 420 corresponds to one example of the software updating section in the basic mode described above.

In saving the update module, the online update tool 420 selects and saves only the update module used in the update of a part of the software selected and set in advance by the user or the manufacturer of the OS 510, the driver 520, and the application 530 installed in the personal computer 100. In the example of the flowchart illustrated in FIG. 6, the OS and the driver are all set in the online update tool 420 as saving targets, and the applications are non-saving targets. An arbitrary software may be set as a saving target for the online update tool 420, but the software desired as the setting target is a software having high reliability of the provider such as an OS, and is a software in which there is slight possibility that the virus software and the like slip into the installed main program or the update module.

The online update tool 420 corresponds to one example of the update file selecting section in the basic mode described above in terms of the selective saving of the update module.

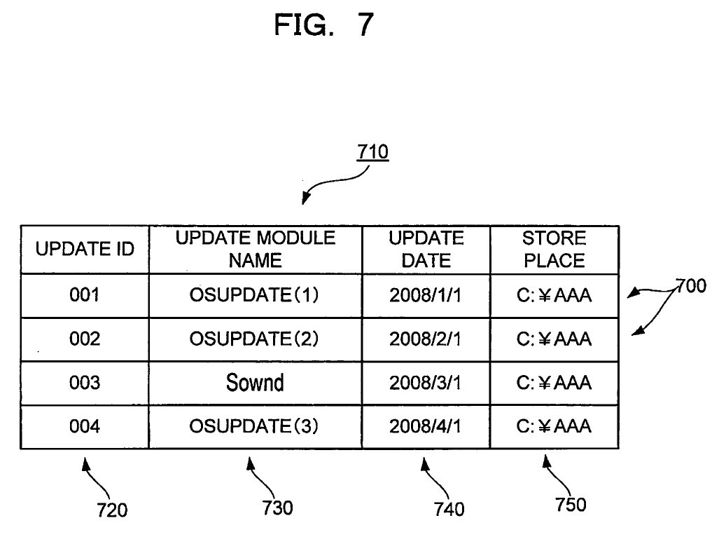

FIG. 7 is a view illustrating the saved update module in the form of a tabulated list.

The tabulated list 710 illustrated in FIG. 7 illustrates four update modules 700 by way of example, where each update module 700 is associated with an update ID 720 for the recovery device to distinguish the update modules 700 from each other, an update module name 730 for the user to confirm the content of each update module 700, an updated date 740 when the software is updated by each update module 700, and a stored region 750 of each update module 700, respectively. Although not illustrated in FIG. 7, each update module 700 is also attached with information indicating the software which each update module 700 sets as the updating target.

In the example illustrated in FIG. 7, the four update modules 700 are all stored in the same storing region, but several storing regions may be used for the stored region to store by classifying according to the setting of the manufacturing company and the like such as the type of software. The description will be continued returning back to FIG. 6.

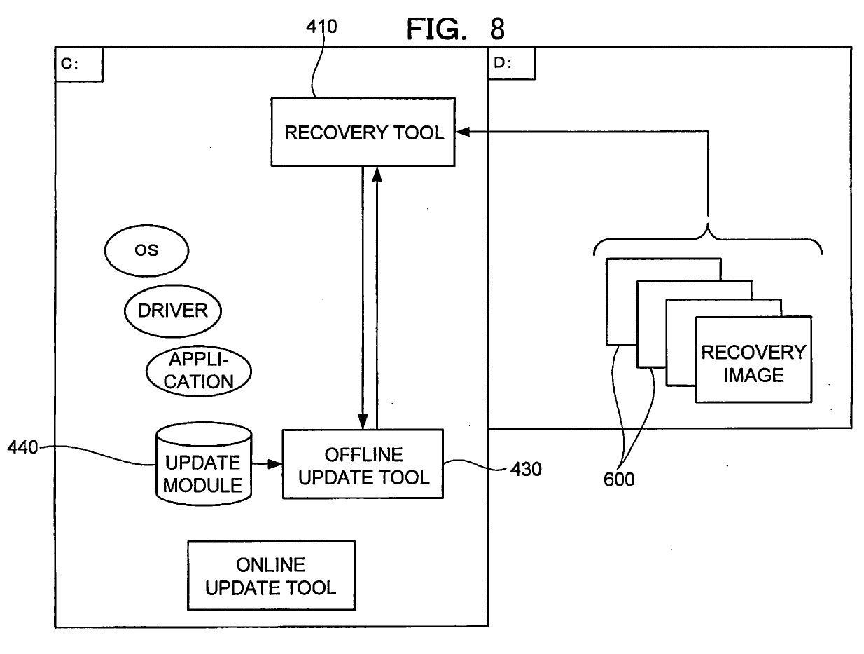

After various software are updated and the update modules are saved in step S101 to step S105 of FIG. 6, the presence of the saved update module is checked on a periodic basis according to the user setting or at an arbitrary time point complying with the user operation (step S106). If the saved update module is present, the presence of the recovery image is checked (step S107). More specifically, as illustrated in FIG. 8, if the content of the saved file 440 is checked by the offline update tool 430 and the update module is present, the offline update tool 430 instructs the recovery tool 410 to check the recovery image file. The recovery tool 410 checks the content of the D drive, where if the recovery image file 600 is present, the ID and the like illustrated in FIG. 5 is notified to the offline update tool 430 with respect to the recovery image file 600.

If the presence of the recovery image file is confirmed in step S107 of FIG. 6, the recovery device indicates to the user a message for confirming whether or not the recovery image is to be updated to the latest. This message is displayed in the form of a confirmation screen described below.

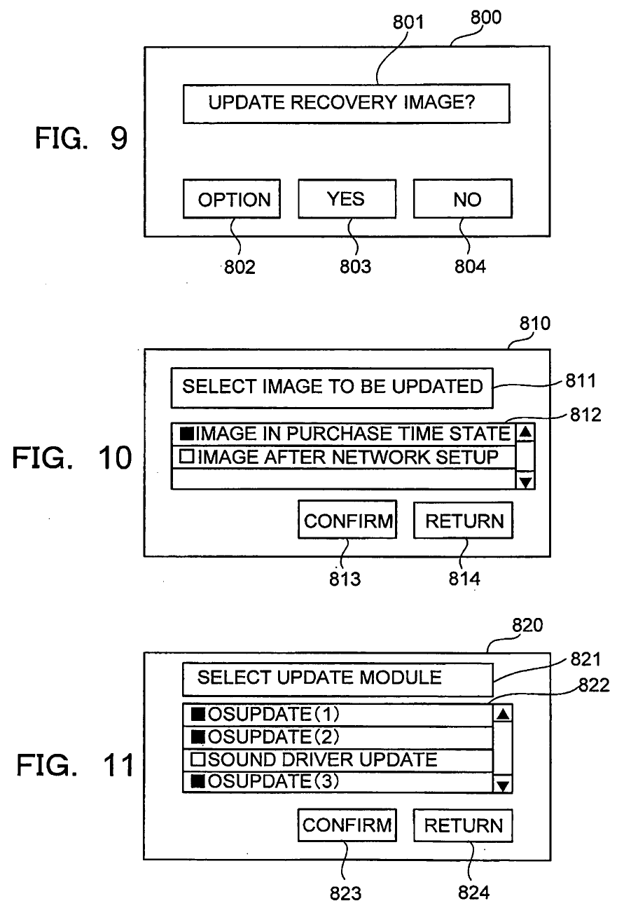

FIG. 9 is a view illustrating the confirmation screen for checking the update to the user.

A confirmation screen 800 is a screen displayed on the display screen 102a of the display 102 illustrated in FIG. 1 according to the instruction from the offline update tool 430 illustrated in FIG. 8.

A message 801 for confirming whether to update the recovery image to the latest is displayed on the confirmation screen 800, and an option button 802 for selecting the options to be hereinafter described, a permit button 803 for permitting the update to the latest, and a prohibit button 804 for prohibiting the update.

When the permit button 803 is selected by the operation of the user, the update of applying the most recent update module (i.e., same updating target with the largest ID number) of the update modules 700 saved in the saved file 440 for the most recent recovery image file (i.e., with the largest ID number) of the recovery image files 600 saved in the D drive is designated for the offline update tool 430. A specific method of updating will be hereinafter described.

When the prohibit button 804 is selected by the operation of the user, it is designated for the offline update tool 430 that any update module is no applied.

When the option button 802 is selected by the operation of the user, an image selection screen of selecting the recovery image file of the updating target is displayed.

FIG. 10 is a view illustrating the image selection screen.

A message 811 for prompting the selection of the updating target is illustrated on the image selection screen 810, and a selection field 812 for illustrating the recovery image file saved in the D drive in a list and accepting the selection of the recovery image file through the click operation, a confirm button 813 for confirming the recovery image file selected in the selection field 812 as the updating target, and a return button 814 for returning to the check screen illustrated in FIG. 9 are arranged.

When the confirm button is selected by an operation of the user, the recovery image file selected on the selection field 812 is designated as the updating target for the offline update module 430, and a module selection screen for selecting the update module used in updating the updating target is displayed. In the example illustrated in FIG. 10, a recovery image file corresponding to the state immediately after purchase is selected as the updating target.

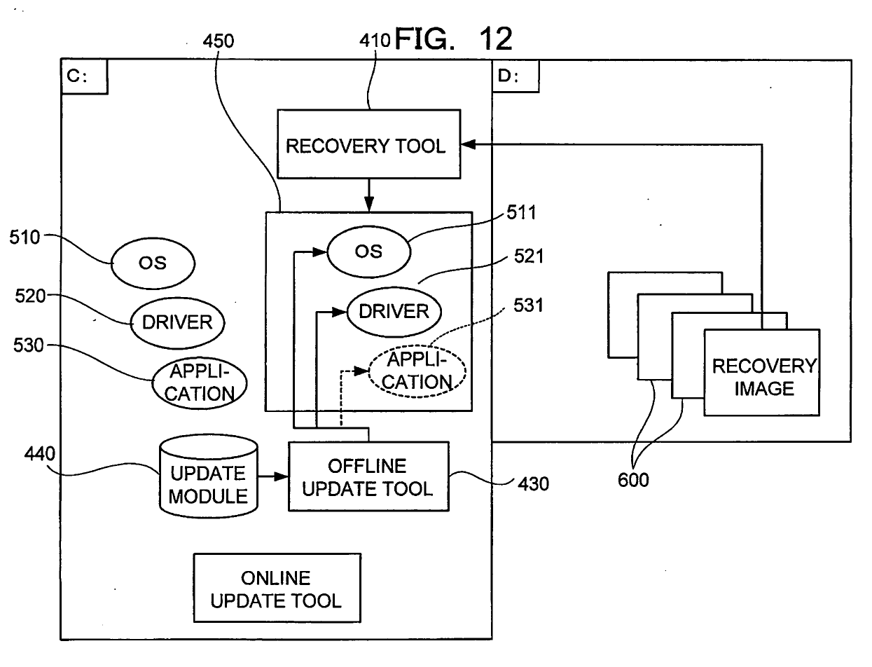

FIG. 11 is a view illustrating a module selection screen.

A message 821 for prompting the selection of the module is illustrated on the module selection screen 820, and a selection field 822 for illustrating the update module saved in the saved file 440 in a list and accepting the selection of the update module through the click operation, a confirmation button 823 for determining the use of the update module selected in the selection field 822 for the update, and a return button 824 for returning to the image selection screen illustrated in FIG. 10 are arranged. Multiple update modules can be selected in the selection field 822 of the module selection screen 820. In the example illustrated in FIG. 11, three update modules used in the update of the OS are selected.

When the confirmation button 823 is selected by an operation of the user, it is designated to the offline update tool 430 that the update module selected in the selection field 822 is used for the update.

When the permit button 803 of FIG. 9 is selected or when the confirmation button 823 of FIG. 11 is selected, some kind of update is ultimately designated, and thus the recovery device recognizes “update” in step S109 of FIG. 6, and executes the update of the image file. However, the recovery image file is all software installed in the C drive at a certain time point collected to one file, and thus is suitable in terms of capacity and the like for saving, but it is technically difficult to update the recovery image file while being saved in the D drive. Thus, the recovery device of the present embodiment realizes the update of the recovery image file through the procedures described below.

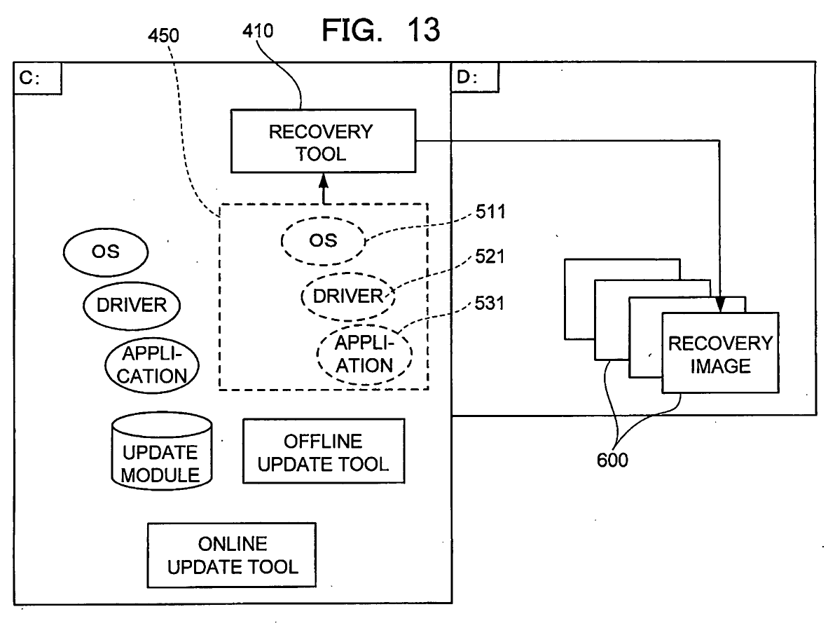

In step S110 of FIG. 6, the recovery image file of the updating target is developed on a temporary work region (temporary folder) on the C drive. More specifically, the recovery tool 410 prepares a temporary folder 450 on the C drive, and reproduces the OS 511, the driver 521, and the application 531 in the temporary folder 450 using the recovery image file of the updating target, as illustrated in FIG. 12. The OS 511, the driver 521, and the application 531 correspond to those reproducing the state of the past time point in the C drive. The reproduced application 531 is also illustrated in FIG. 12, but the application 531 is often not installed at the time point the recovery image file 600 is created, in which case, the application 531 is not reproduced.

The reproduction in the temporary folder 450 by the recovery tool 410 is no big different technically from the normal recovery, and is different from the normal recovery in the meaning of reproducing with the current OS 510, the driver 520, and the application 530 remained as they are.

Next, the recovery device performs update using the update module for each software of the temporary folder in step S111 of FIG. 6. More specifically, the offline update tool 430 obtains the update module from the saved file 440, and updates the OS 511, the driver 521, and the application 531 in the temporary folder 450, as illustrated in FIG. 12. However, in the example of the flowchart of FIG. 6, the saving of the update module is limited to the OS and the driver, as described above, and thus the application 531 is not updated. In FIG. 12, the application 531 may be the updating target depending on the setup of the user, and thus the figure is illustrated as if the application 531 is also updated.

The update on the software in the temporary folder 450 is technically slightly different from the update on the current OS 510, the driver 520, and the application 530 by the online update tool 420 described in FIG. 4, and is the update on the software not in the operation state. The updating technique itself is a technique known as a technique developed to update with the most recent update module without starting up the computer every time, for example, when the manufacturing company of the computer installs the OS and the driver in the computer in a factory.

Thereafter, in step S112 of FIG. 6, the recovery device creates the recovery image file in which all software in the temporary folder are illustrated in a collective manner, and overwrites to save the same to the recovery image file before update. More specifically, as illustrated in FIG. 13, the recovery tool 410 creates the recovery image file 600 in which the OS 511, the driver 521, and the application 530 in the temporary folder 450 are illustrated in a collective manner. The created recovery image file 600 is then overwritten to be saved with respect to the recovery image file 600 used in the development of the OS 511, the driver 521, and the application 531 in the temporary folder 450. The temporary folder 450 is then deleted. As a result, the substantial update of the recovery image file 600 is completed.

The substantial update of the recovery image file 600 is realized through the cooperative operation of the recovery tool 410 and the offline update tool 430, and thus one example of the backup updating section in the basic mode is constructed by the recovery tool 410 and the offline update tool 430.

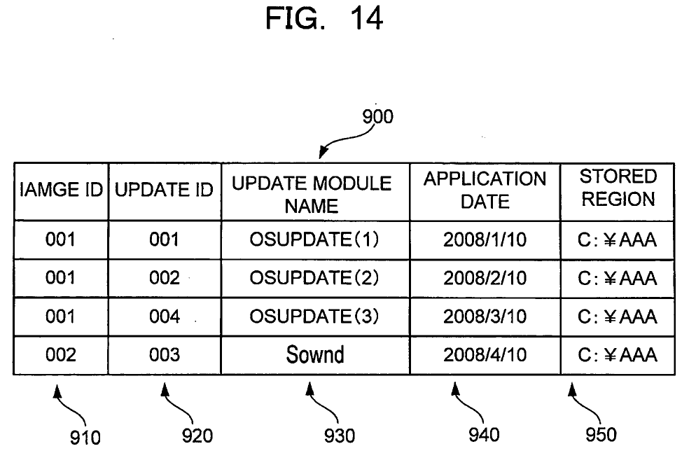

FIG. 14 is a view illustrating one example of the result of update of the recovery image file.

In a tabulated list 900 illustrated in FIG. 14, the result of update in which four update modules are applied to two recovery image files is illustrated.

The image ID 910 in the tabulated list 900 corresponds to the image ID 620 illustrated in FIG. 5, and represents the recovery image file as the updating target. In the example of FIG. 14, the two recovery image files respectively represented by the ID number “001” and the ID number “002” are the updating targets.

The update ID 920 in the tabulated list 900 corresponds to the update ID 720 illustrated in FIG. 7, and the update module name 930 in the tabulated list 900 corresponds to the update module name 730 illustrated in FIG. 7, which represent the update modules used in the update of the recovery image file.

An application date 940 in the tabulated table 900 illustrates the date when the recovery image file is updated.

A stored region 950 in the tabulated list 900 corresponds to the stored region 750 illustrated in FIG. 7, and illustrates the stored region of the update module used in the update of the recovery image file.

Thus, when the current OS 510, the driver 520, and the application 530 are updated as illustrated in FIG. 4, the recovery image file is updated by the update module used in such update.

The recovery image file updated in such manner is used by the recovery tool 410 illustrated in FIG. 4, when required, and is used for the recovery of the C drive. The state of the C drive obtained with such recovery is a state in which only the software installed at the created time point when the recovery image file is created is installed and the software added after such created time point does not exist, and is a state in which the version of each software is the version reflecting the update of after the created time point. Thus, a complicated update processing does not need to be performed after the recovery, and procedures of the recovery is simple.

According to such application mode, the time point in a state in which the reproduction by the recovery is desired can be selected through operation. The recovery tool 410 in the specific embodiment corresponds to one example of the backup creating section in the application mode.

According to such application mode, the capacity of the backup file can be suppressed. The recovery tool 410 in the specific embodiment corresponds to one example serving as both the reproducing section and the update saving section in the application mode, and the offline update tool 430 corresponds to one example of the reproducing and updating section in the application mode.

According to such application mode, the selective update to the backup file desired by a user becomes possible. The offline update tool 430 in the specific embodiment has a function corresponding to one example of the function of the backup updating section in the application mode, as described in FIG. 10.

According to such application mode, the unnecessary update can be omitted with the operation of the user. The offline update tool 430 in the specific embodiment has a function corresponding to one example of the function of the backup updating section in the application mode, as described in FIG. 11.

According to the software updating device and the storage medium storing the software update program of the present disclosure, the procedures of recovery and the like can be simplified.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A software updating device comprising:
a software updating section that obtains through communication an update file for a software installed in an information processing device, and that updates the software using the update file;
an update file selecting section that selects the update file for a piece of software set in advance, the update file being used in update of the piece of software by the updating section, and that saves the selected update file in a predetermined storing place; and
a backup updating section that updates a backup file of the software stored in a predetermined backup place, by using the update file stored in the storing place.

2. The software updating device according to claim 1, further comprising a backup creating section that creates, in response to a predetermined operation, a backup file of the piece of software installed in the information processing device in the backup place.

3. The software updating device according to claim 1, wherein
the backup file stored in the backup place is a backup file that a plural pieces of software are collected together to one; and
the backup updating section includes,
a reproduction section that reproduces in a temporary reproducing place the plural pieces of software from the backup file stored in the backup place,
a reproduction updating section which updates the plural pieces of software reproduced by the reproduction section by using the update file stored in the storing place, and
a update storing section that creates one new backup file corresponding to the plurality of software updated by the reproduction updating section and that stores the one new backup file in the backup place.

4. The software updating device according to claim 1, wherein
the backup place is a place in which a plurality of backup files each corresponding to each of a plurality of statuses of the software respectively are stored as the backup file, and
the backup updating section, in response to a selecting operation of selecting the backup file as a target to be updated from among the plurality of backup files stored in the backup place, updates the backup file selected in the selecting operation.

5. The software updating device according to claim 1, wherein
the storing place is a place in which the update file of each of the plural pieces of software as the update file, and
the backup updating section, in response to a selecting operation of selecting the update file used in update of the backup file from among the plurality of update files stored in the storing place, performs update by using the update file selected in the selecting operation.

6. A computer-readable storage medium storing a software update program which is installed in an information processing device to cause the information processing device to update a software installed in the information processing device; the software update program causing the information processing device to operate as:
a software updating section that obtains through communication an update file for a software installed in an information processing device, and that updates the software using the update file;
an update file selecting section that selects the update file for a piece of software set in advance, the update file being used in update of the piece of software by the updating section, and that saves the selected update file in a predetermined storing place; and
a backup updating section that updates a backup file of the software stored in a predetermined backup place, by using the update file stored in the storing place.
